(19) United States
(12) Patent Application Publication
(10) Pub. No.: US 2024/0104408 A1
(43) Pub. Date: Mar. 28, 2024

(54) CAUSAL INFERENCE ON CATEGORY AND GRAPH DATA STORES

(71) Applicant: 342022, Inc., Newcastle, WA (US)

(72) Inventors: John SCHROETER, Bainbridge Island, WA (US); Frederic L. SAX, Estero, FL (US)

(21) Appl. No.: 18/372,594

(22) Filed: Sep. 25, 2023

Related U.S. Application Data
(60) Provisional application No. 63/410,560, filed on Sep. 27, 2022.

(51) Int. Cl. G06N 5/04; G06F 16/28; G06F 16/901; G06N 20/00

(52) U.S. Cl. CPC G06N 5/04; G06F 16/285; G06F 16/9024; G06N 20/00

(57) ABSTRACT

A causal inference engine makes inferences based on a vector of attributes in a standardized format called a normalized attribute vector. Candidate correlations between the normalized attribute vectors are made via a machine learning algorithm operating on the attributes of the normalized attribute vectors. The candidate correlations are then validated against a set of known mechanisms, in some cases selected by making use of mathematical category theory. Where a candidate correlation is shown to be similar to a mechanism, or composition of mechanisms, the candidate correlation is validated as being causative rather than just a correlation. Where causation can be shown to have a confidence above a predetermined threshold, the correlation is then stored as to be used to validate other correlations in future processing.

### CROSS-REFERENCE TO RELATED APPLICATION

This application claims priority to U.S. Application No. 63/410,560, filed on Sep. 27, 2022, and titled “CAUSAL INFERENCE ON CATEGORY AND GRAPH DATA STORES,” the entire disclosure of which is incorporated herein by reference.

### BACKGROUND

At any one point in time, a huge amount of research and development is being performed at universities, public laboratories, private laboratories, commercial companies, and any number of other institutions. There is tremendous overlap between experiments and other trials being performed, but often the data from these experiments and trials are not systematically correlated or otherwise leveraged. Unless a researcher affirmatively does so, results from one trial are often not used to supplement the results of another. Accordingly, data that could strengthen the accuracy and quality of a research effort goes unleveraged.

In order for a researcher to leverage another's experimental data, that researcher not only needs to know of the other experiment, but also that the other experimental data is in fact applicable to the researcher's original experiment. Different experiments have different protocols, different models, different data formats, and the like. Accordingly, it is not a trivial exercise to determine whether the results of one experiment are applicable to another, let alone how to make those results correlate.

The scientific research involved in the discovery and testing of new medical entities is a particular instance of research for which the need to correlate data from different experiments and trials is more exigent. In the case of clinical trials, such as for drug discovery and testing, experiments are being performed on human beings, many of which have otherwise untreatable illnesses. During a trial, a patient is being told that the medication might do nothing (i.e. , be placebo), make things worse (i.e. , be ineffective), or maybe, just maybe, might make them better. From this context, extracting the maximum value from data goes beyond the needs of making science effective, rather it is exigent from a humanitarian perspective.

Accordingly, there is a need to discover experiments that may relate to other experiments, determine transformations on how to correlate materials and data from different experiments, and to determine what conclusions may be drawn from the correlated materials and data.

### FIGURES

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for correlation of heterogenous models for causal inference and for causal inference on category and graph data stores.

FIG. 2 is a diagram of an exemplary environment for correlation of heterogenous models for causal inference and for causal inference on category and graph data stores.

FIG. 3 is a diagram of an exemplary normalized attribute vector.

FIG. 4 is a flow chart for creating a graph database from normalized attribute vectors.

FIG. 5 is a flow chart for identifying categories from normalized attribute vectors.

FIG. 6 is a diagram of an exemplary environment for causal inference on category and graph data stores.

FIG. 7 is a flow chart for to extract data models for causal inference on category and graph data stores.

FIG. 8 is a flow chart for performing causal inference on category and graph data stores.

FIG. 9 is a flow chart for mapping causal mechanisms to causal inferences in the context of category and graph data stores.

### DETAILED DESCRIPTION

### The Context of Correlation of Heterogenous Models for Causal Inference

### Overview of Models

In scientific method, one generally has a model to validate, where the model often has a set of parameters that represent the state of the model, and a set of rules relating those parameters. An experimenter will make a hypothesis around a model, will design an experiment on how to perturb one or more of those parameters and make observations in an attempt to verify (or intentionally contradict in order to disprove) the hypothesis, and ultimately some aspect of the model.

Models are well known in science. Parameters in mechanical physics include time, position, and mass. The state model has been extended to include non-time dependent parameters including momentum, force, energy, and work, and time dependent parameters including velocity, acceleration, and power. In some cases, parameters are statistically independent, or can be statistically dependent (i.e., derived from other parameters, e.g., velocity may be expressed as a first derivative of position, and force may be expressed as a first derivative of momentum).

Time dependent models are “dynamic” and are sometimes called “dynamical systems.” The study of dynamical systems generally involves one or more ordinary differential equations (ODEs) and/or partial differential equations (PDEs).

By way of example, clinical trials for drug discovery and testing can be evaluations of dynamical systems. For example, consider pharmacokinetic models, which are models of how a substance, for example a drug, is liberated from its respective delivery system, absorbed into a subject, distributed through different tissues and organs of the subject, metabolized by the subject, eliminated from the subject, and the substance's general impact on the subject, such as a drug patient. Specifically, drug absorption by a person is a function of time, and therefore is dynamic. Since drug distribution, metabolism, and excretion are functions of drug absorption (and other time dependent factors), those aspect are also dynamic. As a result, many models under test in clinical trials, including pharmacokinetic models, are comprised of differential equations, many differentiated over time.

Because clinical trials are heterogenous, that is they have different models with different underlying assumptions, it's unclear how to relate those models. For example, some pharmacokinetic models assume a single or multi-compartment model of the body, and others assume no compartments at all. In compartment models, the body is subdivided into one or more compartments, and substances are seen as propagating through those compartments. Given this degree of interactive complexity across the varying trials and research, a capability that allows correlation and causal inference across heterogenous models would be a substantive improvement over any prior art.

Described herein are systems and methods for a causal inference engine that among other things makes use of category theory and dimensional flattening techniques such as with a spatial web to relate heterogenous clinical trials. Before discussing the causal inference engine, we will discuss category theory and dimensional flattening.

### Overview of Category Theory—Categories, Functors, Natural Transformations

One approach to relate what on the surface appear to be incompatible models is to make use of category theory. Category theory is a discipline of mathematics used to relate different mathematical representations. Specifically, mathematical structures, usually abstract algebraic structures, can be organized into categories. Relationships between categories are called functors, and relationships between functors are called natural transformations.

Before turning to categories with respect to causal inference, some pedagogical examples for categories may be in order. Consider two kinds of algebraic structures, first is the group (a set with a binary operation, the set supporting an identity and an inverse over the operation), and a field, (a set with two binary operations, the set supporting an identity and an inverse for each operation). A typical example of a group is the set of integers over addition (the number zero being the identity and subtraction being the inverse). A typical example of a field is the set of real numbers over addition and multiplication. The real numbers support addition in the same way integers do, and the real numbers support multiplication (the number one being the identity and division being the inverse). We say that integers over addition is an object in the category of Groups. Similarly, we say that reals over addition and multiplication is an object in the category of Fields.

The consequence is that two objects being in the same category suggests that a transformation exists to map objects from one object to the other object in a property-preserving way.

In general, mappings are not guaranteed to preserve all properties. For example, a scaling matrix transformation of two-dimensional shape preserves angles but not necessarily distances. It is of interest to identify what properties are indeed preserved across mappings. Specifically, if a first pharmacokinetic model belongs to a first category, and a second pharmacokinetic model belongs to a second category, those models by definition are mathematically heterogenous. The ability to correlate those two heterogenous models relies on the existence of mappings that preserve the properties of those models that experimenters are measuring.

An example is mathematical composition. Recall from algebra that composition of functions involves taking two functions and creating a third function by chaining those two functions. By way of example, within R→R functions (real numbers to real numbers), f(x) and g(x), h(x)=f(g(x)) is an example of composition of functions. Generalizing to category theory, mappings can be composed in the same way, and have identities and are associative.

Note that computer programming can be modeled as a series of compositions. Indeed, the functional programming paradigm is generally performed as a series of compositions and recursions. The consequence is that there are categories called monads that support such chaining via composition, and therefore support mathematical formalisms of programming

Turning to applications of scientific inquiry and working with heterogenous models, note that a first model and a second model, can belong to a first category and a second category respectively. Functors and natural transformations (described in further detail below) help identify mappings that are property-preserving and can be composed, thereby enabling operations on the two heterogenous models despite being in different categories. In the case of clinical trials, note that pharmacokinetic models are oft characterized as a dynamic system comprised of a set of time dependent ordinary differential equations. One can work directly with the differential equations, or one can make use of functionality as informed by monads as to what compositions can be made between the two heterogenous models.

Functors represent mappings between categories. Note that functors can map items in a category to that same category. Alternatively, functors can map between two categories. Functors can be used as a means of property-preserving transformations between a structure in one category and a structure in another category.

The consequence is that if a first object is in one category and a second object is in another category, and a functor between the categories can be identified, this suggests that a transformation exists to map objects from the first object to the second object in a property-preserving way.

In fact, two categories C1 and C2, can be related as a form of weak equivalence, if a type of functor, called a left adjoint functor maps from C1 to C2 and another type of functor, called a right adjoint functor, maps from C2 to C1. The consequence is that objects in these two categories may be mixed and matched provided that transformations satisfying the identified adjoint functors are honored.

Functors themselves can be transformed in such a way to preserve properties. Such transformations are called natural transformations. The consequence is that functors and natural transformations may be used to identify how to construct transformations including via composition.

The foregoing is a very brief outline of category theory, and is not intended to be limiting, but rather to introduce terms used in this disclosure.

### Applying Category Theory to Relate Models

Turning to the relation of models, consider where a first model used in a first experiment is in a first category and a second model used in a second experiment is in a second category. If a functor can be identified between the two categories, then a mapping may be identified that maps elements, such as state variables, and operations within the model, of the first model to elements of the second model.

In the case of where the first category is the same category as the second category, category theory need not be used. However, for algorithms relying on category theory, the identity functor, which is a functor mapping from a category to the same category, and making no changes, may be made use of

In the case where the first category and the second category are different, functors mapping two categories may be used to identify transformations between the first model and the second model, and to identify what properties are preserved across transformation. In this way results from a first model can be applied to a second model, even if the two models are in mathematically different structures. Where natural transformations exist between functors between the same two categories, techniques to refine transformational mappings between the two categories, such as composition.

Additionally, where adjoint functors exist between the two categories, this suggests that some well-defined subset of results from the two models may be aggregated together.

To be clear, data or results from different models need not be combined in their entirety. Rather, properties that represent model state parameters that in turn can demonstrate correlation, or preferably causation should be preserved. The notion of causal inference is the notion that a machine, in particular a computer, can look at a set of data and/or information, and determine whether a relationship between properties is causal. Note that correlation (as opposed to causation) is a mathematical relationship. Specifically, if one can show that one statistical variable is a dependent variable with respect to an independent variable (i.e., the dependent variable is a function of the independent variable), one can demonstrate correlation. However, causation involves semantic analysis, that is to say there is a real-world mechanism that is in fact modeled by mathematical correlation. This involves making additional tests to demonstrate satisfaction of criteria to show that a correlation is in fact a causation as well. Causal inference is the automation of such tests.

In this way, causal inferences using data or results from different models may be identified.

Using the specific example of clinical trials as scientific research, there are at least two specific goals. The first goal is extrapolation. Specifically, usually an earlier stage clinical trial will have a smaller sample size than a subsequent clinical trial, which in turn has a smaller sample size from release to the general public. Accordingly, an experimenter would be interested in understanding how information from a smaller sample size could be extrapolated to project and predict results on a larger sample size. Relating data from other experiments using category theory would increase the sample size and enable extrapolation.

The second goal is particularization. Where a clinical trial covers a relatively large sample size, an experimenter is interested in what would be the likely outcome on a specific individual. For example, a trial can show a result of a sample of 65+ year old non-smoking males with type two diabetes. However, the experimenter would be interested in determining the results for a specific individual, i.e., particularizing to an individual who not only is a 65+ year old non-smoking male with type two diabetes, but also is African American and has a body mass index of 26. Relating data from other experiments using category theory would increase the sample size and parameters under test and enable particularization.

The preceding example discusses particularization via a causal inference engine including via category theory and spatial web, to a particular person. Note that particularization need not be to a particular individual but generally will be to a class or subclass of patients. However, note that particularization taking to its logical conclusion is personalized medicine, that is the application of medical results customized to a specific patient. Specifically, the causal inference engine may be used to create customized therapies and treatments for a specific patient in a specific state at a specific time. Thus, causal inference engine can enable personalized medicine.

### Dimensional Flattening and the Spatial Web

The causal inference engine is also to make use of spatial web techniques including dimensional flattening. The spatial web is the outgrowth of graph database techniques where relations between records, represented as nodes, were stored as links, thereby creating a geometrically related set of records. The benefit of geometric relations is that the geometry could be relied on to determine possible and impossible relationships quickly, and perhaps more importantly to roughly situated related records within a predetermined set of links of one another. Congregating records within a predetermined set of links were sometimes called “clusters” and a cluster could be assigned a semantic interpretation.

Sets of clusters could be used to approximate volumetric shapes called manifolds. In mathematics, a manifold is a many dimensioned shape where the surface is generally continuous. A circle is a 2-dimensional manifold. A sphere is a 3-dimensional manifold. Manifolds can have holes, for example a torus, or a donut shaped shape is a manifold.

In the case of graph databases, a spheroid with a number of records from a graph database defining the spheroids surface is a manifold.

Mathematical manifold theory has a number of techniques to approximate the surface of the manifold with less dimensions. For example, if one gets very close to the surface of a sphere, one could approximate a point on the sphere and items within a predetermined radius with a Euclidean plane. This provides techniques to simplify mathematical analysis.

One benefit is that the data from a graph is not necessarily continuous, but because local areas of a manifold based on data from the graph might be, one could still apply continuous techniques (for example calculus) on the limited local area.

Another benefit is the notion of dimensional flattening. Generally speaking, it is easier to perform mathematical operations using less dimensions. Volume calculations are more complex than surface calculations, which in turn are more complex than linear calculations. Considering that records may have a trillion attributes, each representing a dimension, reducing the number of dimensions under consideration can result in simpler math, less storage, and less computation resources utilized.

### Exemplary Platform for Correlation of Heterogenous Models for Causal Inference

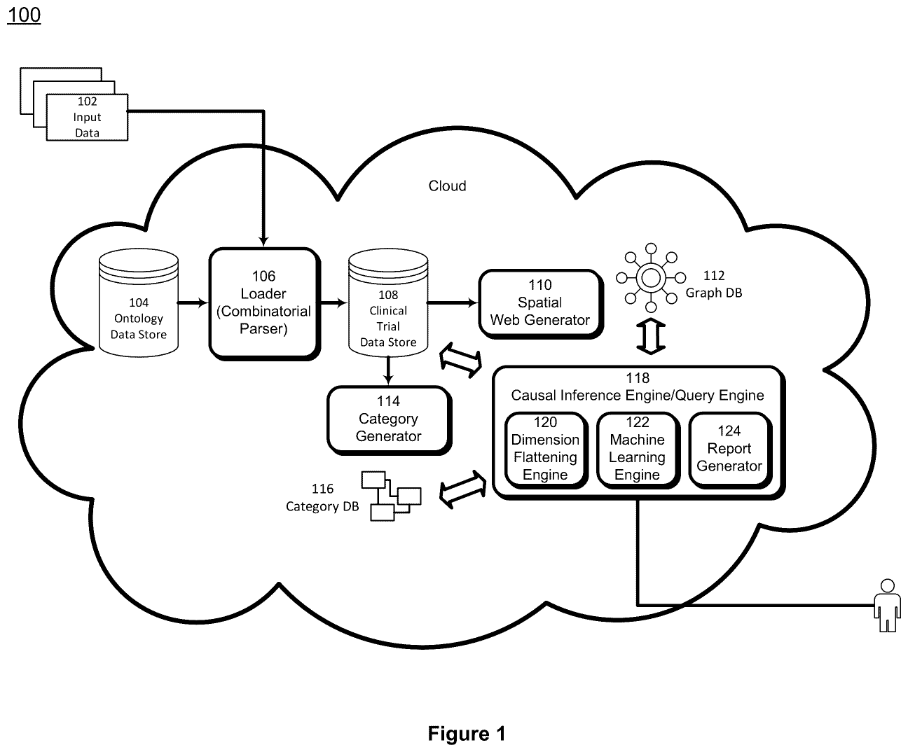

A system and methods for a causal inference engine and surrounding infrastructure, together comprised of one or more software and hardware components described herein, are described. In the present exemplar, information around clinical trial data and experimental data around life sciences are received, transformed such that the data may be manipulated to find relations including causal inference relations making use of category theory and spatial web dimensional flattening techniques. The resulting transformed data, and results of the manipulated data are then queried to find causal inferences and related information. While the present discussion is around clinical trial data, it is to be noted that causal inferences may be found using the present causal inference engine for other sets of data, and the discussion around clinical trial data is not intended to be limiting. FIG. 1 is a context diagram 100 of a platform for the correlation of heterogenous models for causal inference.

The causal inference engine receives input data 102 in the form of a model, and of resulting data, i.e., data showing the results of trial runs on subjects. In the case of clinical data, the model is usually in the form of a pharmacokinetic model, generally a mathematical dynamical system comprised of a set of differential equations. The resulting data are trial runs comprised of the vital statistics of various subjects, human or otherwise, showing doses and fidelity to the pharmacokinetic model. Generally, there will also be natural language notes providing context for results in general or for specific trial runs. In other cases, the data might be non-clinical trial data and may describe chemical or pharmacological phenomena.

Because different input data 102 are expected to have different models and different results, it is expected that the input data 102 will also be in different formats. However, the input data 102 needs to be converted into a standard format, called a “normalized attribute vector.” In this way, the converted data may be mixed and matched during analysis in a consistent and controlled fashion.

Each incoming input data 102 file is expected to have a set of attributes. If one takes all the unique attributes of all the input data 102 files, one can store these attributes into an ontology store 104. The ontology store 104 then identifies unique attributes, and where attributes are duplicative, the ontology store 104 contains synonyms, that is corresponding names for the same attribute across different formats. The ontology store 104 may also store standardized field definitions, including type, and amount of memory. Examples of field definitions include varchar(20) (a string of up to 20 characters), date/time, integer, floating point number, and Boolean.

The input data 102 is accordingly received by a loader 106 software component. The loader 106 comprises a multi-format parser, in some cases a combinatorial parser and accesses the ontology store 104. Based on the ontology store, the normalized attribute vector for each trial data record is created using at least three sections, the first being a reference for the model of data, the second being attributes about the clinical trial such as date, source, and point of contact, and the third being the trial data itself in the form of a set of attributes normalized according to the ontology store 104.

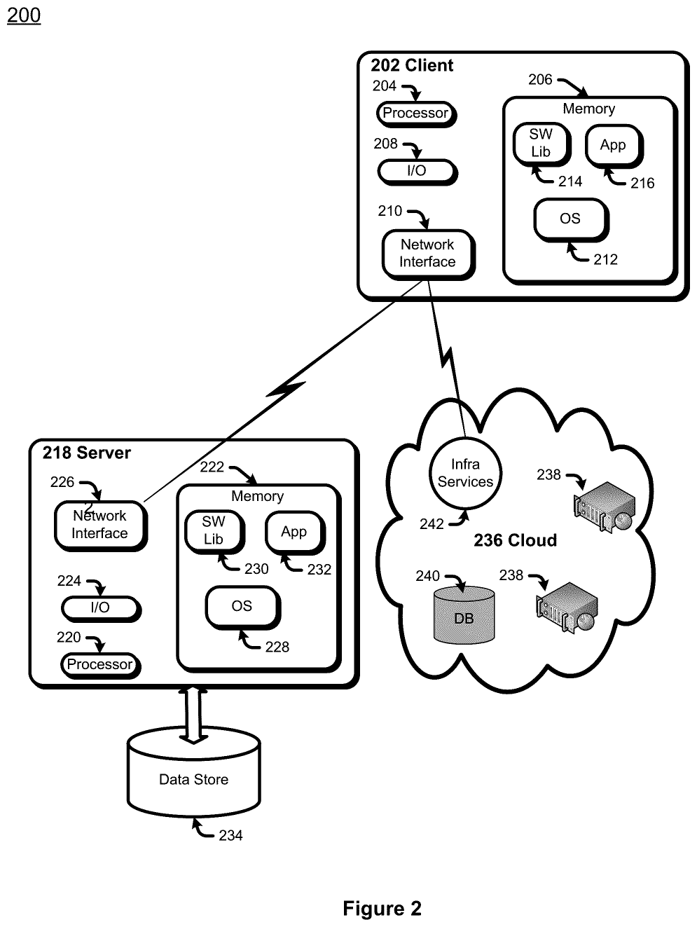

Note that several software components described herein are depicted in FIG. 1 as software services and/or microservices resident in the cloud. However, this is not to foreclose other embodiments where software components are hosted wholly or in part on servers, discrete computers, or microprocessor chips. Alternative hosting is described in additional detail with respect to FIG. 2.

The loader 106 then stores the records transformed into normalized attribute record format into a clinical trial data store 108. Although the records were originally in heterogenous formats because all records are in the same format, the clinical trial data store 108 is now in a state to be analyzed regardless of source.

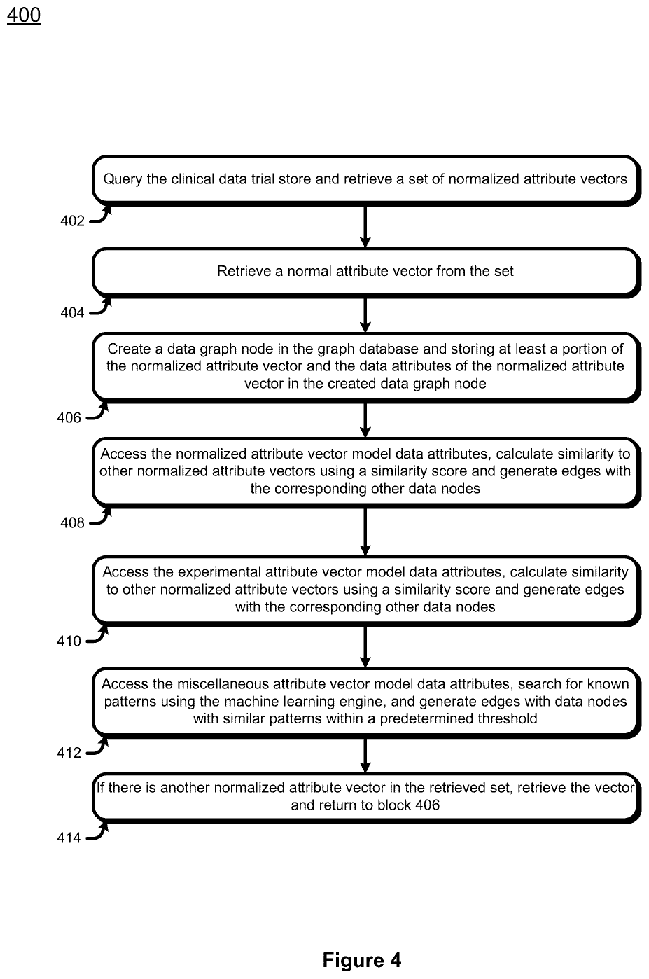

The clinical trial data store 108 may be analyzed via spatial web analytic. Specifically, the clinical trial data store 108 may be stored by a spatial web generator 110 software component which loads the data in the clinical trial data store 108 into a graph database 112 (sometimes called a spatial web database). The spatial web generator 110 takes each record in normalized attribute vector format and accesses the model and clinical trial portion to generate connections in the graph web database 112 between the records. Population of the graph database 112 as performed by the spatial web generator 110 is described in further detail with respect to FIG. 4 below.

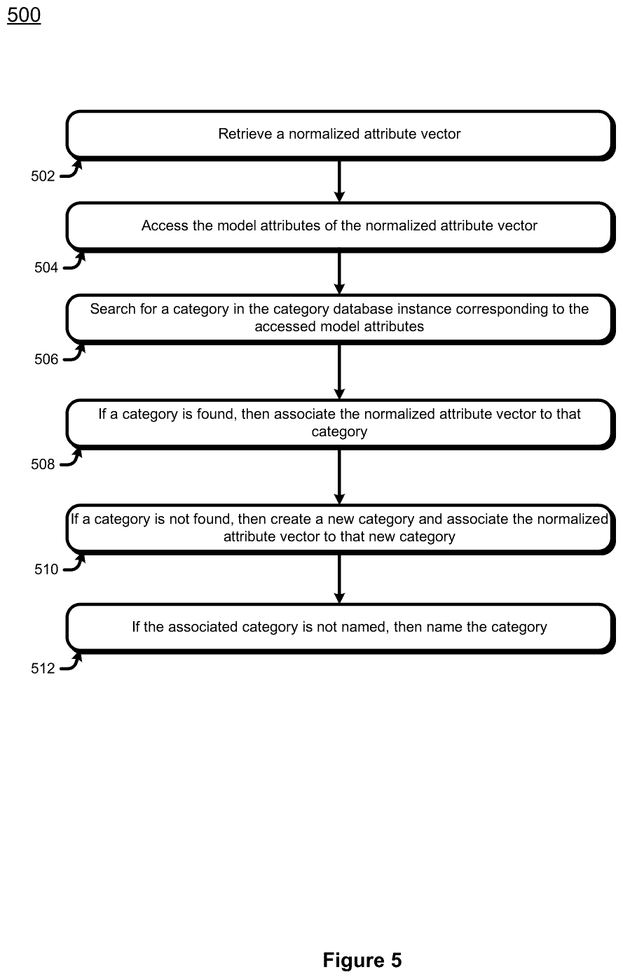

Data in the clinical trial data store 108 may also be analyzed from a category theory perspective. Category generator 114 is a software component that take each record in normalized attribute vector format and accesses the model portions to identify the mathematical properties of the model used. To be clear, a category is not a set of instances of the same model. Rather, a category instance is the definition of a type of mathematical representation (here a model), where the mathematical operations are similar, such that functors and natural transformations may be identified. In practice, most models will be some sort of monoidal category. The category generator 114 is described in further detail with respect to FIG. 5 below.

Upon identifying categories of the models, the category generator 114 stores the identified categories into a category database 116. Along with identified categories, functors, and natural transformations identified by the category generator are also stored in category database 116. In some cases, categories, functors, and natural transformations may also be hand entered.

Once the data from the clinical trial data store 108 is transformed into a graph database 112 and category database 116, the data may then be queried for causal inferences and other relations. This function is performed by a causal inference engine 118 software component which acts as a general query engine.

The causal inference engine 118 is comprised of at least three software components, a dimension (or dimensional) flattening engine 120, a machine learning engine 122, and a report generator 124. The causal inference engine 118 receives queries either programmatically or from a user and provides responses. Performance of queries is described in further detail with respect to the report generator 124 below.

The dimension flattening engine 120 is a software component that reviews data in the graph database 112 and identifies attributes that can be eliminated for purposes of approximating analysis. Specifically, it removes attributes that are unused, and then identifies attributes that if removed, create the least amount of change according to a predetermined optimization function.

The machine learning engine 122 is a software component configured to analyze data in the clinical trial data store 108, the graph database 112, and/or the category database 116. The machine learning engine 122 makes use of machine learning/cognitive network analysis to identify patterns. In particular, the machine learning engine 122 is able to recognize patterns as suggested by category theory, as simplified using dimensional flattening, and to find analogous patterns between the normalized attribute vector representation in the clinical trial data store 108, the category representation in the category database 116, and the graph database 112.

The report generator 124 is a software component that enables both predetermined and ad hoc query capability. The report generator 124 may receive queries and respond to queries either programmatically via APIs or via an interactive query tool. Specifically, the report generator 124 receives queries for either a particular clinical trial, or type of clinical trial, and can return related categories of clinical trials, related clinical trials (as suggested by categories), or amalgamations of results from related clinical trials. In this way, a user may either perform the amalgamation manually or may rely on the causal inference engine 118 to perform the amalgamation.

### Exemplary Environment for Correlation of Heterogenous Models for Causal Inference

Before describing a Causal Inference Engine using correlation of heterogenous models, via FIG. 2, we describe in a diagram 200 an exemplary hardware, software, and communications computing environment. Specifically, the functionality for correlating heterogenous data and performing causal inference is generally hosted on a computing device. Exemplary computing devices include without limitation personal computers, laptops, embedded devices, tablet computers, smart phones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210, may potentially work in concert with the I/O interface 208 and may be a network interface card supporting Ethernet and/or Wi-Fi and/or any number of other physical and/or datalink protocols.

Memory 206 is any computer-readable media which may store software components including an operating system 212, software libraries 214, and/or software applications 216. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 228. In the memory will be an operating system 228, software libraries 230, and server-side applications 232. Server-side applications include file servers and databases including relational databases. Accordingly, the server 218 may have a data store 234 comprising one or more hard drives or other persistent storage devices.

A service on the cloud 236 may provide the services of a server 218. In general, servers may either be a physical dedicated server, or may be embodied in a virtual machine. In the latter case, the cloud 236 may represent a plurality of disaggregated servers which provide virtual application server 238 functionality and virtual storage/database 240 functionality. The disaggregated servers are physical computer servers, which may have a processor, a memory, an I/O interface and/or a network interface. The features and variations of the processor, the memory, the I/O interface and the network interface are substantially similar to those described for the server 218. Differences may be where the disaggregated servers are optimized for throughput and/or for disaggregation.

Cloud 236 services 238 and 240 may be made accessible via an integrated cloud infrastructure 242. Cloud infrastructure 242 not only provides access to cloud services 238 and 240 but also to billing services and other monetization services. Cloud infrastructure 242 may provide additional service abstractions such as Platform as a Service (“PAAS”), Infrastructure as a Service (“IAAS”), and Software as a Service (“SAAS”).

### Exemplary Normalized Attribute Vector

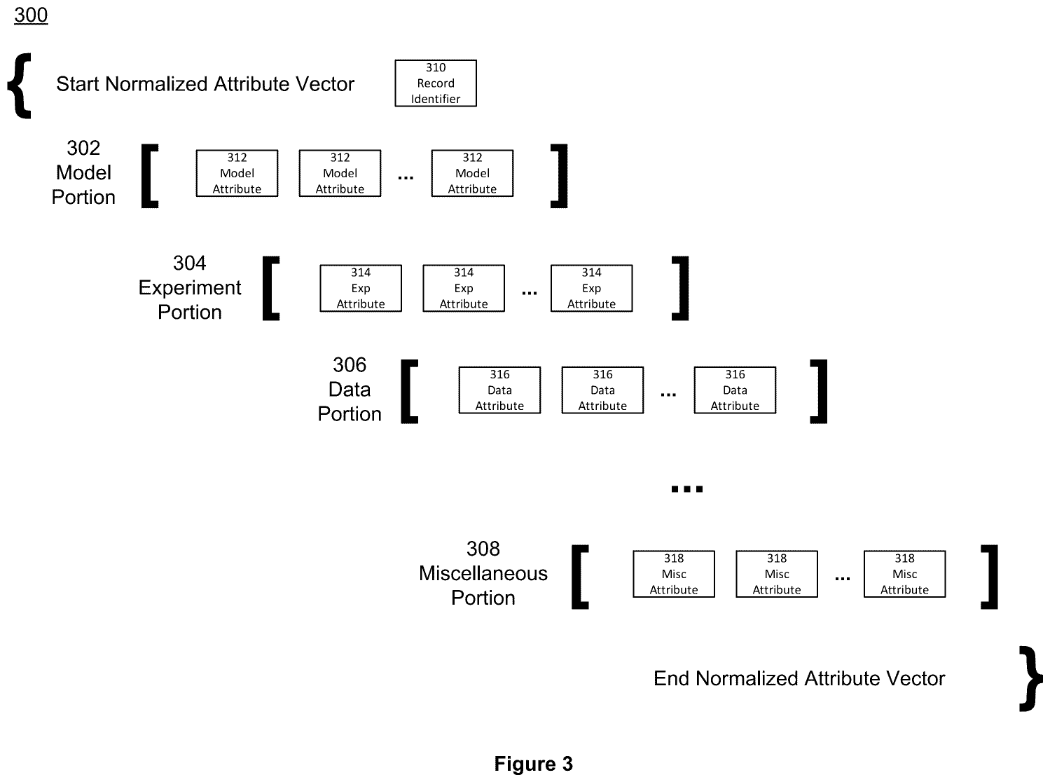

FIG. 3 illustrates an exemplary normalized attribute vector 300. The normalized attribute vector 300 store a set of attributes that describe a record from an arbitrary clinical trial or experimental results. An attribute is a key-value pair where the attribute name represents the key, and some data represents the value. The data may also be a reference to a value rather than the value itself The attribute names are taken from the data in the ontology data store 104.

The normalized attribute vector 300 is comprised of a plurality of attributes. There may be a very large set of potential attributes. In some cases, there may be trillions of attributes. However, it is not the case that all attributes will have assigned values. To organize the attributes, there are four portions of the normalized attribute vector 300. First there is a model portion 302 which contains attributes describing the mathematical or pharmacokinetic model used for the record associated with the normalized attribute vector 300. Then there is an experiment portion 304 which contains attributes describing the experiment and the circumstances of the experiment. Next there is a data portion 306 which provides values representing the experimental results of a trial or experimental run. Finally, there is a is a miscellaneous portion 308, which contains any additional attributes reported.

First there is a normalized attribute vector identifier attribute 310. The identifier attribute 310 is a value guaranteed to be unique. Such a value may be generated by a sequential iterator (e.g., a monotonically increasing integer generator creating 1, 2, 3 . . . ) or by a globally unique identifier (GUID) generator.

The model portion 302 contains enough information in the form of model attributes 312 to determine whether the model in the record corresponding to the normalized attribute vector 300 has the same mathematical characteristics of another model, and therefore should be considered in the same category. Some pharmacokinetic models are comprised of various sets of ordinary differential equations. Others make use of partial differential equations. Some models are container based and others are not. Model attributes 312 describe these aspects and other aspects of a model (or provide references to review the model) as to enable the identification of a predetermined category, to assign the model in the record corresponding to the normalized attribute vector 300 to that category, and then to identify functors and potentially natural transformations associated with the category for application to the model in the record corresponding to the normalized attribute vector 300.

The experiment portion 304 contains enough information in the form of experiment attributes 314 to determine patterns about ensuring the various experiments have similar design and were performed under similar circumstances. Experiment attributes 314 may identify one or more protocols (biological workflows), in the form of steps. Other experiment attributes 314 may identify labs where performed, parties involved in performance, date/time, and other environment aspects. The data in the experiment attributes 314 enable a machine learning engine 122 to identify patterns in data. For example, a machine learning engine 122 might identify a specific lab as having particular accurate and easily reproducible results.

The data portion 306 contains data actual data results in the form of data attributes 316 for a particular trial or experimental run. The data attributes 316 have attribute names taken from the ontology data store 104. Where a particular attribute is not used, the value is set to “not applicable” (as opposed to zero which may be valid value). In this way, one can identify applicable attributes during dimensional flattening.

The miscellaneous portion 308 contains miscellaneous attributes 318 that provide additional information for context. For example, an attribute labeled “Error” may indicate that the test result was based on an erroneously executed run. Another attribute label “Comment” may be a natural language value containing contextual notes. In some cases, the machine learning engine 122 may perform natural language analysis on such natural language attribute values to detect patterns.

### Exemplary Method for Correlation of Heterogenous Models for Causal Inference—Graph Database Instance Generation

FIGS. 4 is a flow chart 400 that shows the manipulation of normalized attribute vectors 300 as stored in the clinical trial data store 108. Specifically, FIG. 4 is a flow chart illustrating an exemplary method for generating a graph database 112 from normalized attribute vectors 300 by the spatial web generator 110.

Turning to FIG. 4, the goal is to take a queried set of normalized attribute records and create a graph database instance stored in graph database 112. Note that graph database 112 can store multiple instances of graph databases. Here we create a new graph database instance. This involves creating data nodes and edges between the data nodes for that instance. In flow chart 400, the edges will be based on manipulation of data stored in the model attributes 302, experiment attributes 304, and miscellaneous attributes 308 of a normalized attribute vector 300.

In block 402, the clinical data trial store 108 is queried according to a set of parameters. If the clinical data trial store 108 is a relational database, with attributes representing fields, the query may be in the form of a structured query language query with parameters referring to fields. Upon execution of the query, a set of normalized attribute vectors is returned in the form of a SQL recordset.

In block 404, the SQL recordset is iterated through. Specifically, a cursor iterated through the records corresponding to normalized attributed vectors one by one. The record, which is comprised of a normalized attribute vector, that is pointed to by the cursor is retrieved or otherwise accessed.

In block 406, a data node in the graph database is added storing at least a portion of the normalized attribute vector 300. In actual practice, only the unique normalized attribute vector identifier 310 is stored. To access attributes of the normalized attribute vector 300, the identifier 310 is used to access attributes to the record stored in the clinical trial data store 108.

In block 408, the model data attributes 302 of the normalized attribute vector 300 just added are retrieved and compared with the model data attributes 302 of all nodes already in the graph database instance. The comparison is performed using a similarity score. If the similarity score is within a predetermined threshold, then an edge between the new node and the existing node in the graph database instance is created.

In block 410, operation is similar as in block 408, except here the experimental data attributes 304 are accessed. As in block 408, the attributes themselves may be compared according to a similarity score and if the similarity score is within a predetermined threshold, then an edge between the new node and the existing node in the graph database instance is created.

In block 412, operation is similar as in blocks 408 and 410, except here the miscellaneous data attributes 308 are accessed. However here, because free form natural language is used, machine learning from the machine learning engine 122 is applied to the natural language fields to identify pattern types. When comparing natural language attributes, where the identified pattern type from the machine learning engine 122 is within a predetermined threshold, then an edge between the new node and the existing node in the graph database instance is created.

In block 414, the cursor is incremented and the recordset is accessed to determine if there is another normalized attribute vector. If there is, then operation returns to block 406. Otherwise, the operation terminated. The result is a graph database instance populated with references to the normalized attributed vectors from the recordset, and edges created based on model attributes 302, experiment attributes 304, and comment and other attributes in the miscellaneous attributes 308.

### Method for Correlation of Heterogenous Models for Causal Inference—Category Identification

Turning to FIG. 5, FIG. 5 is a flow chart 500 that shows the manipulation of normalized attribute vectors 300 as stored in the clinical trial data store 108 to identify categories by the category generator 114. Note that the category database 116 stores categories, functors, and natural transformations. Note further that the category database 116 can also create different instances of category databases, each corresponding to some subset of normalized vector attributes. The goal is to take a normalized attribute vector 300 that is not associated with a category, and to either associate it with a category in the category database 116, or if an appropriate category does not exist, create one in the category database and then associate the normalized attribute vector 300 with the newly created category. For categories stored in the category database 116, each stored category may be associated with a set of model attributes that can be used to comparison purposes when determining whether a normalized attribute vector 300 should be associated with that category.

In block 502, a normalized attribute vector 300 is retrieved. As with blocks 402 and 404, the normalized attribute vector 300 may be part of a recordset retrieved via a SQL query from the clinical trial data store 108 or may simply be a standalone record.

In block 504, the model attributes 302 of the retrieved normalized attribute vector 300 are accessed. Since the model attributes 302 describe the mathematical and/or pharmacokinetic model used, these model attributes 302 may be used to determine a category.

In block 506, the model attributes 302 of the retrieved normalized attribute vector 300 are compared to attributes associated to the various categories in the category database 116. If a category is found, in block 508, the normalized attribute vector 300 is associated with the category. In practice, the category database 116 will not store the full normalized attribute vector 300, but instead will only store the vector identifier 310.

If a category is not found, in block 510 a new category is created in the category database 116. As stated above, stored categories are associated with attributes. Here the attributes associated with the new category are based at least in part on the attributes of the normalized attribute vector 300 under analysis.

Note that the in block 510, the newly created category is not necessarily yet named. At some future time, a name may be manually added, or automatically associated via machine learning.

At the end of this process 500, the result is a category database instance with a full set of categories, each category associated with attributes, and each category associated with at least identifiers of a set of normalized attribute vectors 300. Over time, functors and natural transformations will be identified and added to the category database 116. At that point, in conjunction with graph database 112, causal inferences on the thereby correlated heterogenous models may be performed.

### Context of Causal Inferences on Category and Graph Data Stores

Causal inferences on category and graph data stores apply to scientific research and inquiry in general. However, consider, for example the context of heterogenous medical clinical trials. At this point, we have constructed clinical trial data store 108, category database 116, and graph database 112. The clinical trial data store 108 contains data from multiple heterogenous clinical trials all in a normalized attribute vector formal 300. Accordingly, we are ready to identify causal inferences in the aggregated heterogenous data. In other words, we wish to perform analysis on data to determine whether a factor causes an effect. The issue is that computational methods generally show correlation but not causation. In order to infer that an observed machine learning pattern represents a cause and not merely a correlation, that is to say to perform causal inference, calls for some digression to provide context.

It is well known in scientific method, that when a team of experimenters selects a model as a starting point, they will attempt to validate (or invalidate) the selected model by attempting to perturb one and only one variable in an experiment. The reason is to isolate the perturbed potential cause of observed effects in the experiment. If more than one variable is perturbed, then the experimenter is faced with determining which variable, or which combination of variables caused the observed effects.

Furthermore, it is well known that there is a difference between correlation and causation. With the former, we can only observe that a perturbed variable is statistically present whenever we observe an experimental effect. With the latter, we can show systemically how the perturbed variable is the indicator of a mechanism that creates or otherwise creates conditions for the observed experimental effect. In other words, in causation, we recognize that a statistical effect does not illustrate a causal mechanism. This is only possible with a qualitative model, not merely a quantitative model.

Consider the case of a child in child seat in the back in a car being driven by a parent. The child cannot see what the parent is doing. However, whenever the car veers right or left (i.e., the child feels the car turning), the child also hears a ticking noise coming from the parent having activated the turn signal. The child might be forgiven for thinking that the ticking sound causes the veering effect—quantitatively,

The issue is that the child does not have a qualitative model of the mechanics of turning the car. The child is not aware that there are customs and regulations to enable the driver and car to safely be on the road at the same time as others, and that the signal is for the benefit of those others. The child is not aware that signaling obligations are on the driver, in this case the parent. Furthermore, the child can't see the parent driving, and accordingly can't see that the parent is in fact the mechanism activating a turn signal which is creating the ticking sound.

Correlation can be very persuasive, but can also be very misleading, including in careful scientific inquiry. Consider the geocentric (Earth-centric) model of the solar system promulgated by Ptolemy's Almagest. Today, with general knowledge and acceptance of the heliocentric (sun-centric) model, discussion of the geocentric model is described almost with derision verging on contempt. This is unwarranted. Ptolemy was known to be an expert and the Almagest is replete with some of the most careful and precise star charts of all time. In fact, the Almagest is still used today to determine the motion of stars over the past 2000 years.

The geocentric model required the notion of epicycles to explain planetary retrograde motion, a very unwieldy mechanism. But beyond reputation, the Almagest enabled the prediction of eclipses and occultations (events where stars, planets, and other astronomical observable bodies crossed paths). That ability made very serious scientists to have confidence in the geocentric model and epicycles, regardless of the mathematical and conceptual awkwardness. In fact, the Copernican heliocentric model proposed using perfect circles and could not predict eclipses accurately, thereby weakening the case for the heliocentric model.

The flaw was that there was no mechanism to explain why an epicycle should occur in the first place. Scientists only knew that you could get consistent, repeatable, and predictable effects. Until Newton proposed the notion of gravity, there was no basis as to why a model should be heliocentric or geocentric. And until Newton developed mechanical physics and the calculus (contemporaneously with Leibniz), and until Kepler modified the heliocentric model to use ellipses instead of circles, to enable predictions of eclipses and occultations was there a causal basis for the heliocentric model.

Turning back to our discussion of clinical trials, it is particularly important to have a causal, not merely correlative basis, for understanding the mechanisms of proposed drugs. Note that drugs may have side effects, many quite unpleasant. If the specific causal mechanisms can be identified, then side effects can also be predicted, and the drug developed can be directed towards minimizing side effects and maximizing proper targeting.

To this end, clinical trials, and medical/pharmacological research make use statistical methods such as ANOVA to identify and isolate correlations but make use of rigorous factors to determine the likelihood of causation. The starting point for such factors is the Hill Criteria which include as its factors: (1) evaluations of strength, (2) consistency and causation, (3) specificity, (4) temporality and causation, (5) biological gradient, (6) plausibility, (7) coherence and causation, (8) experimental result, and (9) analogy. The factors are described in greater detail in Hill's 1965 paper, “The Environment and Disease, Association or Causation?” Note that the criteria have been evolved over time and are not dispositive.

The foregoing is all to motivate the combination of category and graph databases. Machine learning and cognitive networks are inherently statistical in nature. At best, they can show correlation. However, categories are deterministic. If two objects are instances of the same category, we can say that those instances are the same in some well-defined, property-preserving respect. Similarly, functors and natural transformations are deterministic and are both well-defined and property-preserving. In other words, we can use categories and categorical relationships to demonstrate causation, suggested by observed correlations in graphs and machine learning, by associating a mechanic with a category/functor/natural transformation structure.

Because category theory, by definition, supports mathematical composition, we can start with simple, smaller, well understood mechanics, associate the mechanics as an interpretation of category theory artifacts, and can construct more complex mechanisms using composition of those category theory artifacts. Accordingly, if we are confident in the simpler causality mechanics, then we can be confident in the compositions of those simpler mechanics in to larger and more complex causations.

### Machine Learning Configuration for Causal Inferences on Category and Graph Data Stores

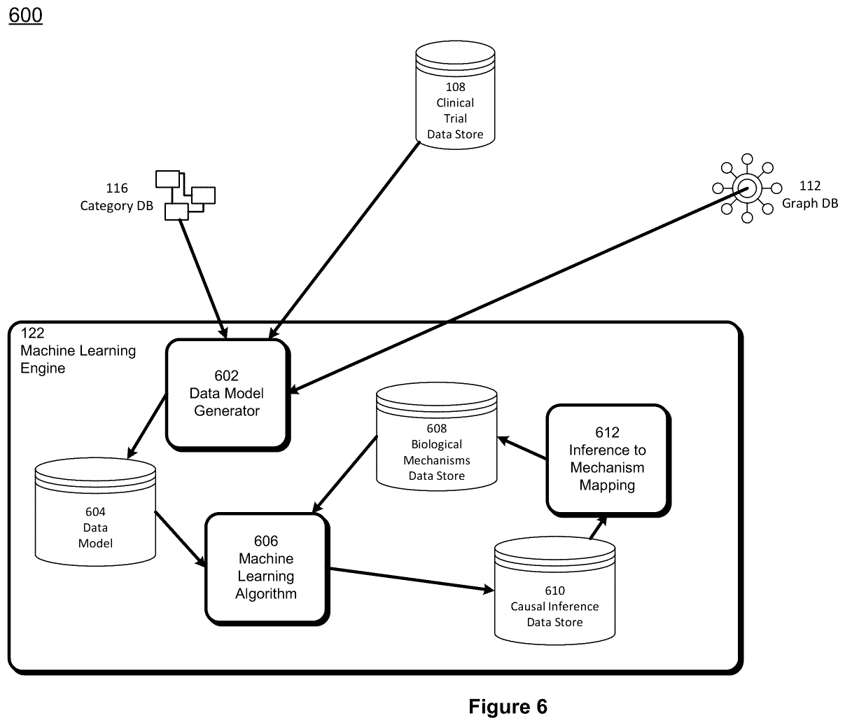

FIG. 6 is a diagram 600 for an exemplary machine learning configuration for causal inferences on category and graph data stores. Specifically, the machine learning engine 122 creates data models from the category database 136 and the graph database 112 and if needed supplements the data with data directly from the clinical trial data store 108. The machine learning engine 122 has a table of validated mechanics mapped to category theory artifacts. The machine learning engine 112 then uses this table to search for patterns that are compositions of those validated mechanics

A query engine 118 receives a query from a user to search for causal inferences on a set of data. The query engine 118 interprets the received query as a search for correlations in data and furthermore to validate those compositions of validated known mechanisms. To do so, architecturally a data model generator 602 software component converts the received query and retrieves data from the category database 116, the graph database 112, and in some cases the clinical trial data store 108, into a software data model 604. The generation of a data model is described in further detail with respect to FIG. 6.

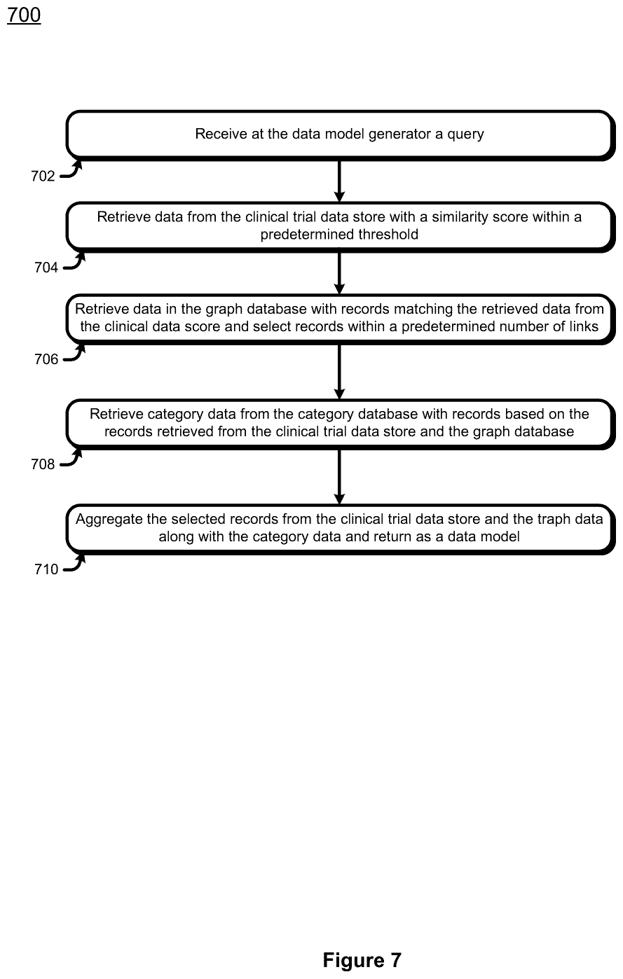

A machine learning algorithm 606 software component then searches for various patterns correlating patterns in the clinical trial data store 108 data and the graph database 112 data. The correlated patterns are then validated by the machine learning algorithm 606 using a biological mechanisms data store 608, a data store of validated patterns mapped to an interpretation of a known biological mechanism, i.e., a trusted causal mechanism. If the machine learning algorithm 606 can discern a mathematical category theory-based composition (or other mathematical composition) of known biological mechanisms from the biological mechanisms data store 608, then the result is returned to a causal inference data store 610. The query engine 118 may then return a result to the querying user based at least on some portion of the returned causal inference. The operation of the machine learning algorithm 606 is described in further detail with respect to FIG. 7.

In some cases, the biological mechanisms data store 608 is supplemented with new mechanisms. Where the statistical confidence of a detected causal inference exceeds a predetermined threshold, the machine learning engine 122 may be configured to promote an inferred causation in the causal inference data store 610 to a trusted and validated biological mechanism to be stored in the biological mechanisms data store 608. This function is performed by the inference to mechanism mapping 612 software component.

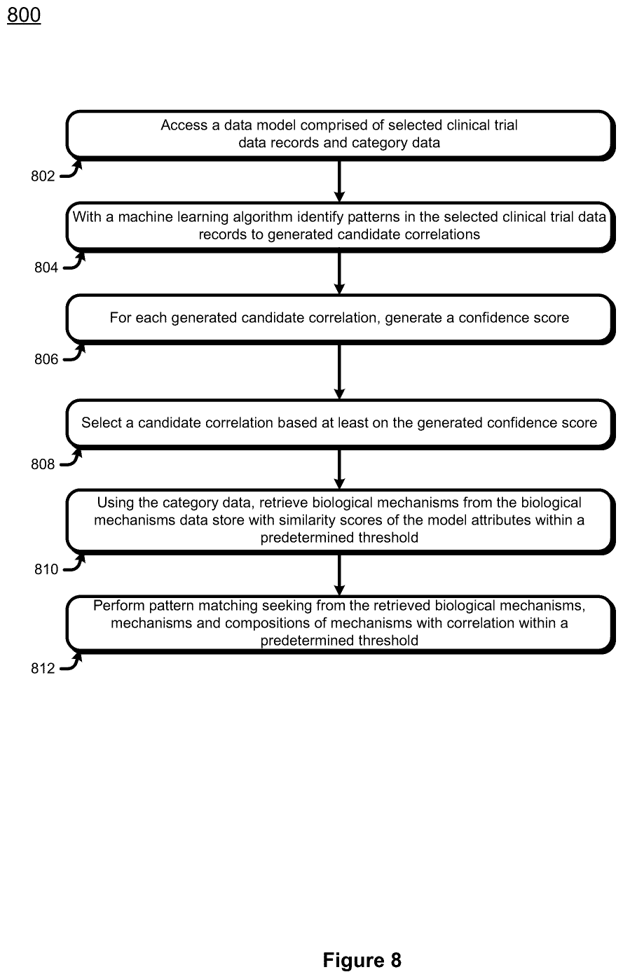

Note that in some cases, such as in training and tuning the inference to mechanism mapping, candidate mechanisms for promotion may be surfaced to a developer, administrator, or other user as part of training a machine learning model or developing rules for a rules engine. However, the inference to mechanism mapping software component 612 is itself implemented in a fully automated fashion making use of rules engines and/or machine learning models that would reflect choices during identifying rules for the rules engine and/or training machine learning models. The operation of the inference to mechanism mapping 612 is described in further detail in FIG. 8.

### Data Model Generation

As stated above, the data model generator 602 converts queries into data models. FIG. 7 is a flow chart 700 of this process.

In block 702, the data model generator 602 receives a query from a user as forwarded by the query engine 118. The query includes a set of attributes normalized according to the ontology data store 104. In other words, the attributes use the same names and value rules set forth in the ontology data store 104. In this way the attributes in the query can be matched to attributes in records in normalized attribute vector 300 format.

In block 704, the data model generator 604 queries data from the clinical trial data store 108 that match the query attributes using a similarity score. Data with a similarity score within a predetermined threshold are selected.

In block 706, the data model generator 606 queries the graph database 112 for all records within the selected records from block 704. The selected records may then be supplemented or reduced based on records in the graph database 112 within a predetermined number of links. In the case that some records in the graph database 112 are within the predetermined number of links, those records are added to the selected set. Where the records are beyond the predetermined number of links within the graph database 112, those records may be retained in the selected set, or alternatively may be deleted, depending on the querying user's desired statistical confidence.

In block 708, the data model generator 602 queries the category database to retrieve at least some categories, functors, and natural transformations based on the selected records. Specifically, the selected records are associated with models as represented by their model attributes 302.

In block 710, the data model generator 602 then aggregates the final selected records and the retrieved categories, functors, and natural transformations into a data model 604. Recall that manipulations of the data are possible because all records are in normal attribute vector 300 format.

### Performing Machine Learning Causal Inference

Once we have a data model 604, we can search for patterns using machine learning to determine correlations and causations. FIG. 8 is a flow chart 800 of such an exemplary process.

In block 802, a machine learning algorithm 606 is applied to data model 604. The machine learning algorithm 606 is specifically seeking data with correlating results and is further configured to seek correlations that are compositions of biological mechanisms in the biological mechanisms data store 608.

In block 804, the machine learning algorithm 606 identifies candidate correlations. Specifically, the machine learning algorithm 606 seeks for correlations of data based on similar data of data from the clinical trial data store 108 data attributes making use of various similarity scores. It also looks for patterns in graph database 112 on the basis of proximity within the graph database 112. The patterns from the clinical trial data store 108 and the patterns from the graph database 112 are then correlated together. Note that the data model generator 602 created the data model 604 in a similar process. However, here because we are seeking correlations to more fine-grained predetermined thresholds.

In block 806, the machine learning algorithm 606 generates a confidence score for each identified candidate correlation. The confidence score is a function of the error calculation for the machine learning algorithm 606.

In block 808, a subset of records corresponding to a candidate correlation is selected based on the calculated confidence of the candidate correlation exceeding a predetermined threshold.

In block 810, the machine learning algorithm 606 uses categories, functors, and natural transformation in the query to retrieve biological mechanisms in the biological mechanisms data store 608 with similarity scores within a predetermined threshold. Recall that the biological mechanisms data store 608 does not merely store mathematical constructs, it also stores interpretation of those constructs as biological mechanisms that are trusted. In this way, a composition that is otherwise mathematically feasible can be rejected as not being biologically possible mechanically.

In block 812, the machine learning algorithm then performs pattern matching to seek biological mechanisms and compositions of biological mechanisms from the biological mechanisms data store 608 within a predetermined threshold.

In block 814, where the pattern matching is within a predetermined threshold, the candidate correlation is returned as a candidate causal inference and is stored in the causal inference data store 610. The query engine 118 may then return some subset of the candidate causal inferences to the user or alternatives may apply further processing such as with the inference to mechanism mapping 612.

### Automated Inference to Mechanism Mapping

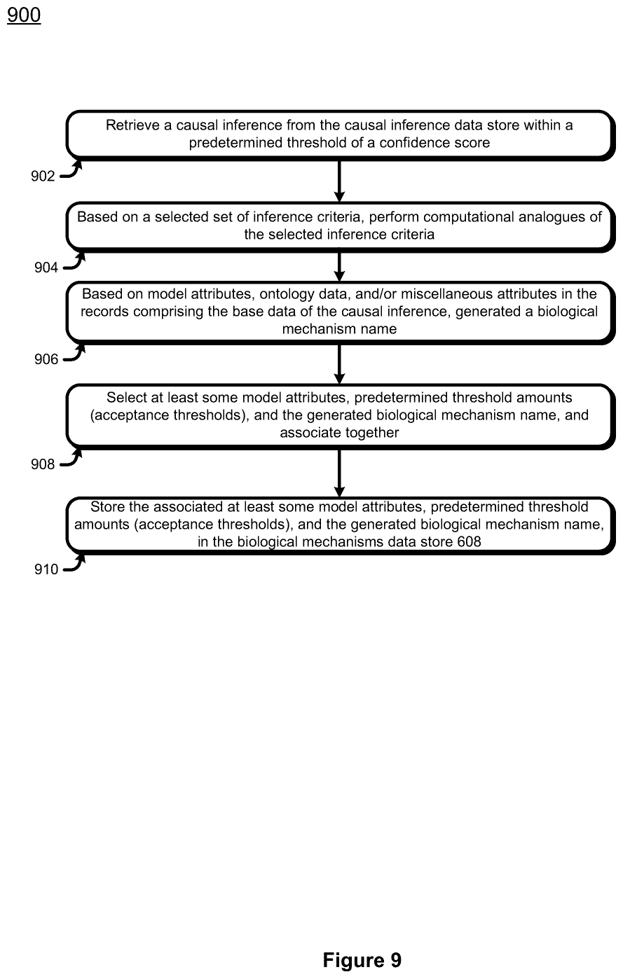

At this point we have a set of causal inferences stored in the causal inference data store 610. Because the causal inferences are compositions of trusted biological mechanisms in the biological mechanisms data store 608, the inferences are consistent with those mechanisms. It would be advantageous to store the inferences as a biological mechanism itself in the biological mechanisms data store 608. In this way, the computation expended to identify the pattern need not be expended again and again and can be used to discover further patterns and mechanisms. However, the causal inferences are not yet validated and therefore are not yet to be trusted. Furthermore, a biological mechanism has not necessarily been identified to associate as an interpretation of the underlying mathematical structure. FIG. 9 is a flow chart 900 of a process to validate causal inferences and therefore store in the biological mechanisms data store.

In block 902, the inference to mechanism mapping 612 software component retrieves a causal inference from the causal inference data store 610 based at least on a confidence score. In general, the inference to mechanism mapping 612 seeks relative high confidences.

In block 904, the inference to mechanism mapping applies a computational mapping of a predetermined set of causality criteria.

Examples computational mapping include performing computations analogues of the Hill Criteria mentioned above. For example, regarding the Hill Criterion of plausibility, where compositions are mathematically but not biologically possible, candidate causal inferences may be eliminated. Similarly, the Hill Criterion of biological gradient of the records may be computed, and curve fitting algorithms applied to determine a confidence score. Where the confidence score is within a predetermined threshold, the candidate causal inference may be accepted for storage in the biological mechanisms data store.

In block 906, candidate names for the biological mechanism may be generated by the inference to mechanism mapping. Specifically, machine learning may be applied to the names of the models, data in the ontology data store, but also parsed text in the miscellaneous attributes 308. In some cases, an administrator or user may intervene to provide a name for the mechanism as well.

In block 908, a subset of the model attributes and predetermined thresholds are associated with the causal inference.

In block 910, the causal inference, including the model attributes, predetermined thresholds, and the name generated in block 906 are stored as a biological mechanism in the biological mechanisms data store 608. The causal inference is now ready to be used in subsequent machine learning analysis by machine learning algorithm 606.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system to generate and manage data models for causal inference, comprising:
a computer processor;
a memory configured to store computer executable instructions and computer readable data; and
a data model generator software component, configured to query and receive data in the form of normalized attribute vectors, each vector comprised of mathematical model attributes, experiment attributes, and experimental data attributes, from one or more databases, to generate data models from the received normalized attribute vectors, and to store the generated data models in a data model database.

2. The system of claim 1, wherein the one or more databases include a category database and a graph database.

3. The system of claim 1, comprising:
a machine learning algorithm software component configured to identify patterns in the normalized attribute vectors, to identify candidate correlations and calculate a confidence score for each correlation, and to store at least some of the candidate correlations based at least on the confidence score; and
a causal inference store, configured to store causal inferences based at least on the candidate correlations identified by the machine learning algorithm

4. The system of claim 3, comprising a biological mechanism data store, wherein the machine learning algorithm is communicatively coupled to the biological mechanism data store and the calculation of the confidence score is based at least on some information from the biological mechanism data store.

5. The system of claim 4, comprising an inference to mechanism mapping software component configured to generate confidence scores in causal inferences in the causal inference store, and to store causal inferences whose scores meet a predetermined threshold in the biological mechanisms data store.

6. The system of claim 5, wherein the generation of confidence scores is based on a rules engine.

7. The system of claim 5, wherein the generation of confidence scores is based on a machine learning routine.

8. A method to perform causal inference, comprising:
receiving, at a data model generator software component, a query;
retrieving data from at least one database storing one or more normalized attribute vectors, each normalized attribute vector comprised of a plurality of attributes;
for each normalized attribute vector in the at least one database, calculating a similarity score between the respective normalized attribute vector attributes and the query; and
at the data model generator software component, generating a data model from the normalized attribute vectors whose calculated similarity scores meet a predetermined similarity score threshold.

9. The method of claim 8, further comprising:
retrieving from a graph database storing one or more normalized attribute vectors, one or more normalized attribute vectors that are stored within a predetermined number of links in the graph database from a normalized attribute vector whose calculated similarity scores meet the predetermined similarity score threshold; and
aggregating the normalized attribute vectors whose calculated similarity scores meet the predetermined similarity score threshold and the normalized attribute vectors that are stored within the predetermined number of links in the graph database into a data model comprised of a set of normalized attribute vectors.

10. The method of claim 8, further comprising:
retrieving from a category database storing one or more normalized attribute vectors, one or more normalized attribute vectors in a mathematical category related to a mathematical category of a normalized attribute vector; and
aggregating the normalized attribute vectors whose calculated similarity scores meet the predetermined similarity score threshold and the normalized attribute vectors that are in a mathematical category that relates to a mathematical category of a normalized attribute vectors whose calculated similarity scores meet the predetermined similarity score threshold, into a data model comprised of a set of normalized attribute vectors.

11. The method of claim 10, wherein the relationship of mathematical categories is one of the following:
the categories are the same; or
the categories are adjoint.

12. The method of claim 10, wherein the relationship of mathematical categories is that they categorically commute.

13. A method to validate correlations in a causal inference engine, comprising:
at a machine learning algorithm software component, receiving a data model comprised of a plurality of normalized attribute vectors, each normalized attribute vector including a plurality of mathematical model attributes;
at the machine learning algorithm software component, generating candidate correlations between two more normalized attribute vectors in the data model based on patterns between attributes of normalized attribute vectors, and a machine learning model based on the attributes;
at the machine learning algorithm software component for each generated candidate correlation, generating a confidence score; and
validating each generated candidate correlation based at least on the corresponding generated confidence score, and storing the validated correlations as causal relationships in a causal inference data store.

14. The method of claim 13, wherein the generated confidence score is a function of the machine learning error rate of the machine learning algorithm software component.

15. The method of claim 13, comprising:
at the machine learning algorithm software component, retrieving records from a biological mechanism data store that have mathematical attributes that have a similarity score to a normalized vector attribute within a predetermined threshold,
wherein the validation of the generated candidate correlation is based on the similarity score of the mathematical attributes.

16. The method of claim 15, wherein the similarity score of the mathematical attributes is based on compositions of records from the biological mechanism data store.

17. The method of claim 16, wherein the composition of records is based on using mathematical category theory techniques.

18. The method of claim 13, comprising:
at an inference to mechanism mapping, receiving a set of inference criteria encoded as computational analogues into a rules engine;
at an inference to mechanism mapping, retrieving from the causal inference data store a correlation between at least two normalized attribute vectors;
performing the computational analogues of the inference criteria on the retrieved correlation; and
if the inference criteria are met within a predetermine criteria, storing the correlation in the biological mechanisms data store.

19. The method of claim 18, wherein the inference criteria is the Hill Criteria for Causation.

20. The method of claim 18, further comprising:
retrieving model attributes of the normalized attribute vectors comprising the correlation;
retrieving synonym data on the model attributes from an ontology store;
applying a machine learning algorithm to generate a name for the correlation; and
storing in the biological mechanisms data store the generated name with the correlation.
